(19) United States
(12) Patent Application Publication
(10) Pub. No.: US 2019/0011650 A1
(43) Pub. Date: Jan. 10, 2019

(54) OPTICAL COUPLING MEMBER AND OPTICAL MODULE

(71) Applicant: SUMITOMO ELECTRIC INDUSTRIES, LTD., Osaka (JP)

(72) Inventors: Takayuki SHIMAZU, Osaka (JP); Takeshi INOUE, Osaka (JP)

(73) Assignee: SUMITOMO ELECTRIC INDUSTRIES, LTD., Osaka (JP)

(21) Appl. No.: 16/018,666

(22) Filed: Jun. 26, 2018

(30) Foreign Application Priority Data
Jul. 4, 2017 (JP) 2017-131453

(51) Int. Cl. G02B 6/42

(52) U.S. Cl. CPC G02B 6/423; G02B 6/428; G02B 6/4239; G02B 6/426

(57) ABSTRACT

An optical coupling member that includes a main body and an electrode is disclosed. The main body consists essentially of glass. The main body comprises a first surface, a second surface opposite to the first surface, and a plurality of holes or grooves each extending from the second surface toward the first surface. The electrode is disposed on the first surface of the main body. An optical module that includes the optical coupling member and an optical device is also disclosed. The optical device is disposed on the first surface of the main body so as to face the plurality of holes or grooves.

### CROSS-REFERENCE TO RELATED APPLICATION

The present application claims the benefit of priority to Japanese Patent Application No. 2017-131453, filed on Jul. 4, 2017, the content of which is incorporated herein by reference in its entirety.

### TECHNICAL FIELD

The present invention relates to an optical coupling member, and an optical module.

### BACKGROUND

Japanese Unexamined Patent Publication No. JP2000-347072 discloses an optical module where a supporting member into which an optical fiber is inserted is embedded with an optical device. In the optical module, the supporting member positions the optical fiber and the optical device with respect to each other such that an end surface of the optical fiber faces the optical device. In order to improve the position accuracy of the optical fiber with respect to the supporting member in this optical module, a resin in a melted or softened state is prepared, the distal end of the optical fiber is provided therein and is covered therewith, and the supporting member made of the resin in close contact with the optical fiber is formed.

### SUMMARY

This disclosure provides an optical coupling member. The optical coupling member comprises a main body consisting essentially of glass, and an electrode. The main body comprises a first surface, a second surface opposite to the first surface, and a plurality of holes or grooves each extending from the second surface toward the first surface. The electrode is disposed on the first surface of the main body.

This disclosure also provides an optical module. The optical module comprises the above optical coupling member, and an optical device disposed on the first surface of the main body to face the plurality of holes or grooves.

### BRIEF DESCRIPTION OF THE DRAWINGS

The foregoing and other purposes, aspects and advantages will be better understood from the following detailed description of embodiments of the invention with reference to the drawings, in which:

FIG. 1 is a perspective view of an optical module according to one embodiment;

FIG. 2 is a diagram showing a state where optical fibers are inserted into an optical coupling member;

FIG. 3 is a perspective view of the optical coupling member of the optical module shown in FIG. 1;

FIG. 4 is a perspective view of an optical device of the optical module shown in FIG. 1;

FIG. 5 is a diagram of a modification example of an optical module;

FIG. 6 is a perspective view of the optical coupling member of the optical module shown in FIG. 5;

FIG. 7 is a perspective view of the optical coupling member and the optical device which are included in the optical module shown in FIG. 5;

FIG. 8 is a sectional view of the optical coupling member and the optical device shown in FIG. 7;

FIG. 9A is a sectional view of another modification example of a main body of the optical module shown in FIG. 5;

FIG. 9B is a sectional view of yet another modification example of a main body of the optical module shown in FIG. 5;

FIG. 10 is a diagram showing another modification example of an optical module according to one embodiment;

FIG. 11 is a perspective view of an optical module shown in FIG. 10 as viewed from a lower surface thereof; and

FIG. 12 is an exploded view of the optical module shown in FIG. 10.

### DETAILED DESCRIPTION

### Problem to be Solved by this Disclosure

The optical module described in JP2000-347072 improves the position accuracy of the optical fiber with respect to the supporting member. However, the supporting member of this module is formed of a resin and the heat resistance of the supporting member is low. Consequently, when the optical module is mounted on a circuit board or the like through reflowing, the supporting member is thermally deformed to cause a strain. Accordingly, the optical module has a possibility that mounted portions exfoliate and members which are included in the optical module and whose heat resistances are low deteriorate. In addition, since the resin generally absorbs sound waves, flip chip bonding through ultrasonic waves whose mounting accuracy is high cannot be used when the optical device is mounted in the supporting member, and thermal flip chip bonding is used instead. Consequently, it is sometimes difficult to embed the optical device on the supporting member accurately. Furthermore, since heat is applied to the supporting member during the reflowing, thermal deformation occurs in the supporting member. Thus, there is a possibility that coupling between the optical fiber held by the supporting member and the optical device cannot be made in conformity with the design, and the coupling efficiency decreases.

### Advantageous Effect of this Disclosure

The optical coupling member and the optical module according to this disclosure can improve the optical coupling efficiency.

### DESCRIPTION OF EMBODIMENT OF PRESENT INVENTION

In accordance with an embodiment of the present invention, an optical coupling member of one aspect of the present invention comprises a main body consisting essentially of glass, and an electrode. The main body comprises a first surface, a second surface opposite to the first surface, and a plurality of holes or grooves each extending from the second surface toward the first surface. The electrode is disposed on the first surface of the main body.

In the above optical coupling member, the main body consists essentially of glass. Accordingly, in comparison with a case where a main body is formed of a resin, the heat resistance of the optical coupling member can be improved to make this member resistant to thermal deformation. The heat resistance is thus provided, thereby suppressing the thermal deformation of the main body during mounting the main body on the circuit board or the like through heat application (for example, reflowing or the like). Consequently, the exfoliation of the mounted components and the deterioration of the members whose heat resistances are low are suppressed. In addition, as the material of the main body is glass, absorption of the ultrasonic waves by the main body is suppressed. Accordingly, the optical device can be mounted on the main body using flip chip bonding through ultrasonic waves, for example. The optical device can be accurately mounted on the main body. Thus, this optical coupling member can improve the optical coupling efficiency.

In an embodiment, the plurality of holes or grooves each may have tapered shapes becoming smaller from the second surface toward the first surface. In this aspect, the diameters of the holes or grooves on the second surface can be slightly larger than the diameters of the optical fibers. Consequently, this embodiment prevents the distal ends of the optical fibers from coming into contact with the main body and being chipped when the optical fibers are inserted from the second surface into the holes or grooves.

In an embodiment, inner surfaces of the plurality of holes or grooves may have tapered shapes having an inclination of 1° or more from central axes of the respective holes or grooves. In this aspect, alignment is gradually made when the optical fibers are inserted from the second surface into the respective holes or grooves. Consequently, this embodiment can achieve smooth insertion of the optical fibers.

In an embodiment, the plurality of holes or grooves may each penetrate from the second surface to the first surface. This embodiment can easily form the holes or grooves in the main body.

In an embodiment, the plurality of holes or grooves may extend from the second surface to the middles of the paths reaching the first surface and be non-penetrated. In this aspect, the distal end of the optical fiber can be in contact with the bottom surface of the hole or groove, thereby facilitating the positioning of the optical fiber. Furthermore, this aspect can prevent the distal end of the optical fiber from coming into contact with the optical device. Consequently, the embodiment prevents optical device from being broken or the like.

In an embodiment, the main body may comprise lenses at the distal ends of the respective holes or grooves. In this aspect, the lenses condense light between the optical fibers mounted in the respective holes or grooves in the main body and the optical device disposed on the first surface of the main body. Accordingly, this embodiment can achieve a high optical coupling efficiency.

In an embodiment, the main body may further comprise a positioning hole extending from the second surface toward the first surface. This aspect facilitates the position adjustment with an optical connector that comprehensively holds the plurality of optical fibers, and can easily achieve insertion of the optical fibers into the respective holes or grooves in the main body.

In an embodiment, the main body may have a rectangular shape, and a distance between the first and second surfaces facing each other may be smaller than 2 mm. This embodiment provides a small optical coupling member.

In an embodiment, the first surface may include a recess for arranging the electrode therein, the electrode may be accommodated in the recess so that an outer surface of the electrode may be flush with an outer surface of the first surface other than the recess. This embodiment provides a smaller optical coupling member. Further, when the optical device is mounted on the optical coupling member, the mounting can be easily performed by this embodiment.

In accordance with another embodiment of the present invention, an optical module of one aspect of the present invention comprises the optical coupling member described in the above and an optical device disposed on the first surface of the main body so as to face the plurality of holes or grooves. This aspect provides the optical module comprising the optical device.

In an embodiment, the optical module may further comprise a circuit board, and the optical coupling member may be joined to the circuit board. This embodiment provides the optical module comprising the circuit board.

In an embodiment, the optical module may further comprise a drive circuit driving the optical device. The drive circuit may be mounted on the circuit board, and be electrically connected to the optical device via the electrode. This embodiment provides the optical module comprising the drive circuit.

In an embodiment, the optical module may further comprise a drive circuit driving the optical device. The drive circuit may be accommodated in a recess provided on the outer surface of the main body other than the first and second surfaces, and be electrically connected to the optical device via the electrode. This embodiment can further downsize the optical module, and can treat this module as a module component that integrally includes the drive circuit.

In an embodiment, the optical module may further comprise a plurality of optical fibers arranged in the respective holes or grooves of the optical coupling member. This embodiment provides the optical module comprising the optical fibers.

In an embodiment, the plurality of optical fibers may be fixed to the respective holes or grooves with a photocurable resin adhesive. According to this aspect, since the material of the main body is glass, the plurality of optical fibers can be preferably fixed into the respective holes or grooves with the photocurable resin adhesive.

### Details of Embodiments of the Present Invention

Hereinafter, an optical module having an optical coupling member according to an embodiment is described in detail with reference to the drawings. The present invention is not limited to these examples, and is indicated by the scope of claims, and meanings equivalent to the scope of claims and all the modifications within the scope are intended to be included. In each drawing, the same or corresponding parts are assigned the same symbols. Redundant description is omitted.

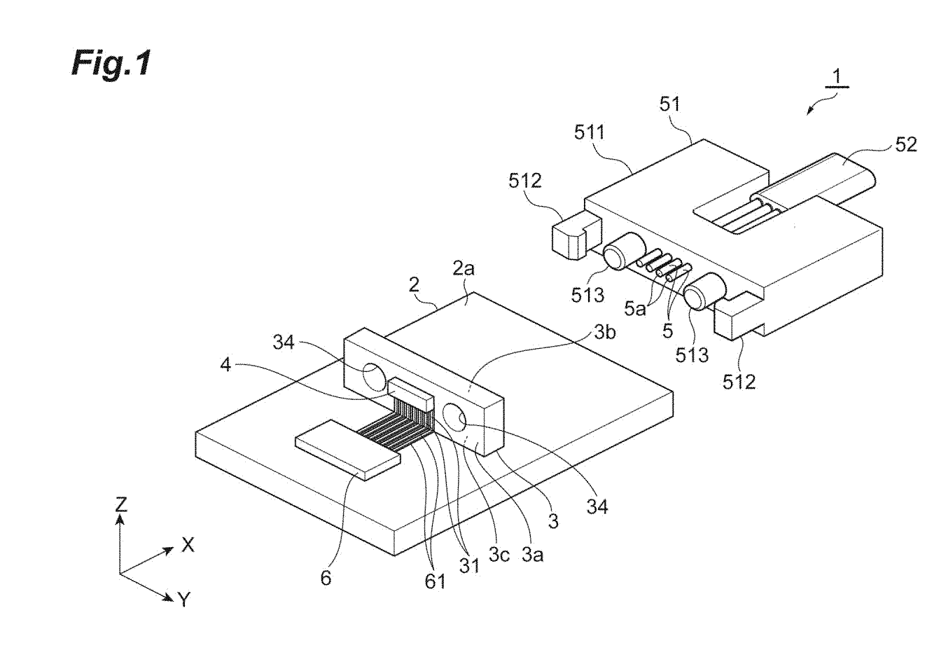

FIG. 1 is a perspective view of an optical module according to one aspect of this embodiment. As shown in FIG. 1, the optical module 1 comprises a circuit board 2, an optical coupling member 3, an optical device 4, a plurality of (four in this embodiment) optical fibers 5, a holding member 51, a hold member 52, and a drive circuit 6. The circuit board 2 includes a principal surface 2a extending in an X-Y plane. The optical coupling member 3 and the drive circuit 6 are mounted on the principal surface 2a. The optical device 4 includes a light emitting device, such as a vertical cavity surface emitting laser (VCSEL) chip, or a light receiving device, such as a photodiode (PD), or a combination of both the devices. The optical device 4 is mounted at a substantial center of one surface 3a of the optical coupling member 3. The optical device 4 is electrically connected to the drive circuit 6 mounted on the circuit board 2, via a plurality of electrodes 31 (described later in detail) provided on the surfaces 3a and 3c of the optical coupling member 3 and via a plurality of electrodes 61 provided on the principal surface 2a of the circuit board 2.

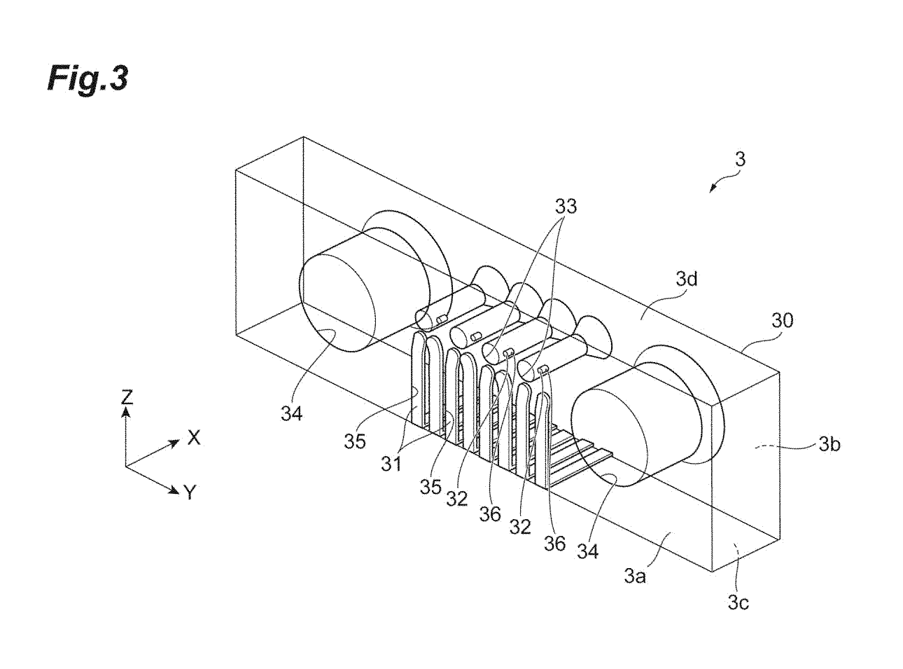

The optical fibers 5 are optically coupled to the optical device 4 by the optical coupling member 3. The outer diameter of the optical fiber 5 may be, for example, about 125 μm, and is an outer diameter substantially equivalent to (slightly smaller than) the diameter of each of holes 33 (see FIG. 3) provided on a surface 3b opposite to the surface 3a of the optical coupling member 3. The optical fibers 5 are held by the holding member 51. The holding member 51 includes a holder 511, a pair of fasteners 512, and a pair of protruded positioners 513. The plurality of optical fibers 5 are inserted into respective holes formed in the holder 511, and are held by the holder 511.

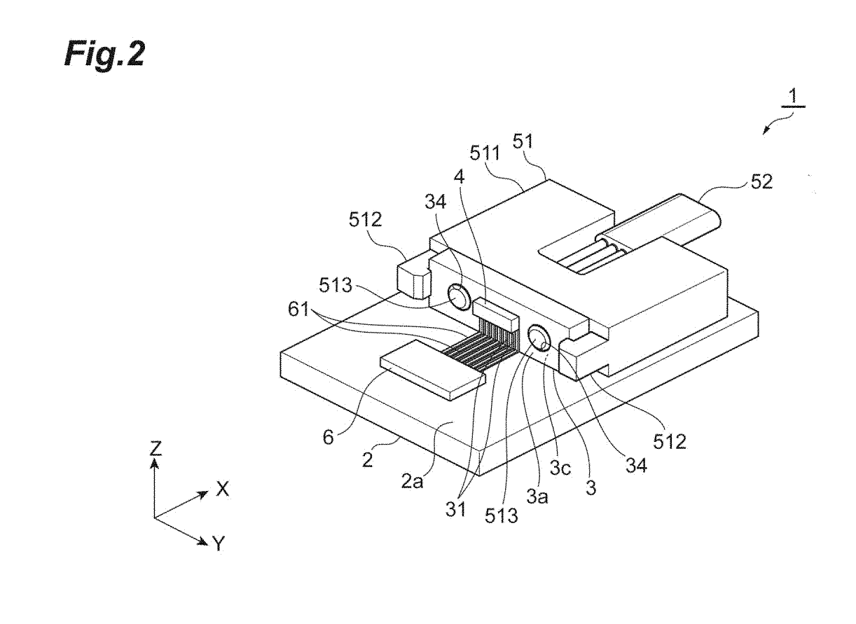

FIG. 2 is a diagram showing a state where the optical fibers 5 shown in FIG. 1 are inserted into the optical coupling member 3. As shown in FIG. 2, the holding member 51 is attached to the optical coupling member 3 by the pair of fasteners 512. The pair of positioners 513 are inserted into a pair of positioning holes 34 formed in the optical coupling member 3, so that the holding member 51 is positioned with respect to the optical coupling member 3. The relative positions of the optical fibers 5 to the positioners 513 coincide with the relative positions of the holes 33 to the positioning holes 34. That is, it is set such that when the pair of positioners 513 are inserted into the pair of positioning holes 34, the optical fibers 5 can be inserted into the respective holes 33. The plurality of optical fibers 5 are supported by the hold member 52. As described above, the plurality of optical fibers 5 are mounted on the optical coupling member 3 in the state of being held by the holding member 51.

Next, the details of the optical coupling member 3 are described. FIG. 3 is a perspective view of the optical coupling member 3 of the optical module shown in FIG. 1. As shown in FIG. 3, the optical coupling member 3 comprises the main body 30, the electrodes 31, and the mechanical pads 32. The external shape of the main body 30 is a rectangular shape, and has the first surface 3a and the second surface 3b, which are parallel to each other. The distance (thickness) between the first surface 3a and the second surface 3b facing each other can be, for example, smaller than 2 mm. Alternatively, the distance may be more than 2 mm. The material of the main body 30 is glass. For example, fabrication may be made using silica glass, which is transparent to light having a wide wavelength band including visible light. At the main body 30 of the optical coupling member 3 formed of the transparent material, for example, the total light transmittance for light having a wavelength ranging from 480 to 670 nm may be 60% or higher in a case where the thickness is 1 mm. Accordingly, when the optical device 4 is mounted on the optical coupling member 3, the positioning can be made while confirmation is made from the opposite second surface 3b or the like. As the material of the main body 30 of the optical coupling member 3 is glass, the main body 30 has heat resistance. Accordingly, adverse effects (expansion etc.) due to heat when the optical device 4 is mounted on the optical coupling member 3 or when the optical coupling member 3 is mounted on the circuit board 2 can be reduced.

The first surface 3a of the optical coupling member 3 is provided with the plurality of (eight in this embodiment) electrodes 31, and a plurality of (four in this embodiment) mechanical pads 32. The second surface 3b disposed opposite to the first surface 3a of the optical coupling member 3 is provided with a plurality of holes 33 that extend toward the first surface 3a. The plurality of holes 33 each penetrate from the second surface 3b to the first surface 3a. The plurality of holes 33 are holes for allowing the optical fibers 5 to be inserted therein. The plurality of holes 33 are each chamfered on the second surface 3b. However, chamfering is not necessarily applied. The plurality of holes 33 are formed in series along a Y-axis direction. The numbers of electrodes 31, mechanical pads 32 and holes 33 correspond to the number of light receivers or light emitters (hereinafter also represented as “light receiving/emitting devices”) (four light emitters or light receivers in this embodiment), which are included in the optical device 4. One light receiving/emitting device is provided with a pair of electrodes 31, one mechanical pad 32, and one hole 33.

The second surface 3b of the optical coupling member 3 is provided with a pair of positioning holes 34 extending toward the first surface 3a. The positioning holes 34 each penetrate from the second surface 3b to the first surface 3a. The positioning holes 34 are holes for allowing the positioners 513 of the holding member 51 to be inserted thereinto. The positioning holes 34 are each chamfered on the second surface 3b. However, chamfering is not necessarily applied.

The first surface 3a of the main body 30 is provided with a plurality of (eight in this embodiment) recesses 35 for allowing the plurality of electrodes 31 to be arranged thereon. The plurality of recesses 35 extend lower than the holes 33 on the first surface 3a along a Z-axis direction to a lower surface 3c. The plurality of recesses 35 are formed along the Y-axis direction. A pair of recesses 35 correspond to one hole 33. The depth of the concave 35 is equivalent to the thickness of the electrode 31. The plurality of electrodes 31 are accommodated in the respective recesses 35. The outer surfaces of the electrodes 31 accommodated in the respective recesses 35 are flush with the outer surface which is of the first surface 3a and is other than the recesses 35.

The first surface 3a of the main body 30 is provided with a plurality of (four in this embodiment) recesses 36 for allowing the plurality of mechanical pads 32 to be arranged thereon. The plurality of recesses 36 have circular shapes as viewed in an X-axis direction. The plurality of recesses 36 are formed along the Y-axis direction. One recess 36 corresponds to a pair of electrodes 31 and one hole 33. The depth of the recess 36 is equivalent to the thickness of the mechanical pad 32. The plurality of mechanical pads 32 are accommodated in the respective recesses 36. The outer surfaces of the mechanical pads 32 accommodated in the respective recesses 36 are flush with the outer surfaces of the mechanical pads 32 and the outer surface which is of the first surface 3a and is other than the recesses 36.

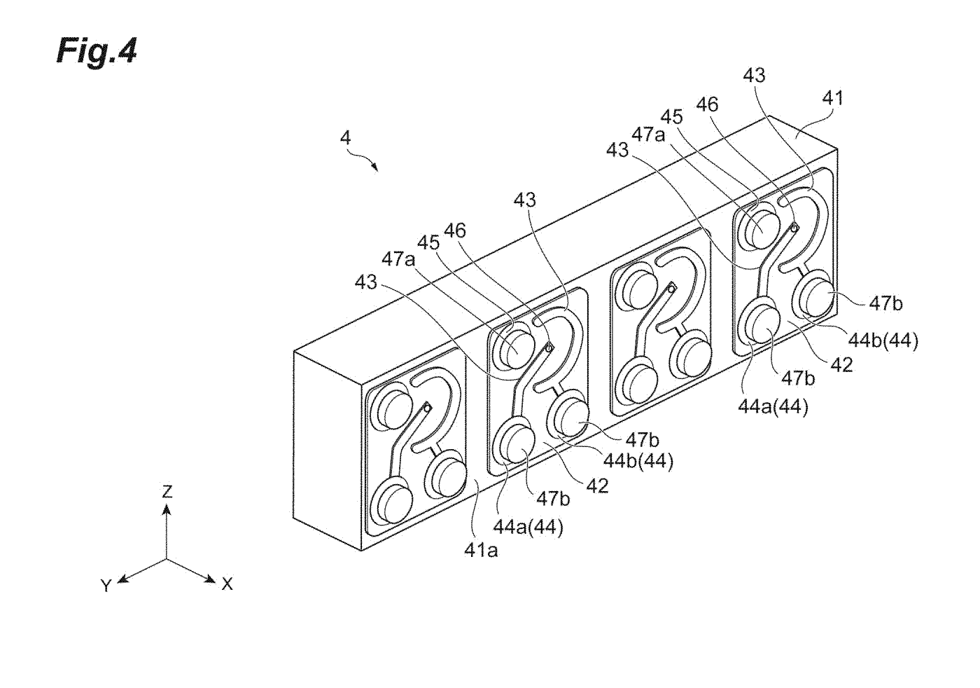

FIG. 4 is a perspective view of the optical device 4 of the optical module shown in FIG. 1. As shown in FIG. 4, the optical device 4 is, for example, a VCSEL chip, and comprises a substrate 41, a plurality of (four in this embodiment) light emitting regions 46. The plurality of light emitting regions 46 are disposed on the surface 41a of the substrate 41 next to each other along the Y-axis direction. The center interval between the light emitting regions 46 in the Y-axis direction corresponds to the center interval between the holes 33 in the Y-axis direction. Electrode pads 44 (anodes 44a/cathodes 44b) for configuring surface emitting lasers (e.g., VCSELs), electric wiring portions 43 connected to the respective electrode pads 44, and mechanical pads 45 that are electrically insulated from the other members are formed on element planes 42. The light emitting region 46 is formed at the other distal end of the electric wiring portion 43 connected to the electrode pad 44 (anode 44a) and at a portion surrounded by the electric wiring portion 43 connected to the electrode pad 44 (cathode 44b). Bumps 47a and 47b for flip chip joining to a glass substrate are forming on the electrode pad 44 (anode 44a/cathode 44b) and the mechanical pad 45. In the above description, the case where the plurality of light emitting elements are formed on the common substrate 41 and constitute the optical device 4 is described. Alternatively, each light emitting element or each light receiving element may be formed on an individual substrate. In the above description, the case where the optical device 4 includes the light emitting device is described. Alternatively, the optical device 4 may include a chip including a light receiving device, such as a PD, or a chip including a light emitting device (VCSEL chip, etc.) and a light receiving device (PD chip) in a mixed manner. Further alternatively, the optical device 4 may comprise one light receiving/emitting device (light emitting device or light receiving device). In the case where the optical device 4 includes the light emitting device and the light receiving device in the mixed manner, the light emitting device and the light receiving device may be formed on another common substrate. In the case where the optical device 4 comprises one light receiving/emitting device, one hole 33 or the like is provided for the optical coupling member 3.

Here, FIG. 2 is referred to again. The optical coupling member 3 is electrically joined to the circuit board 2. Specifically, the optical coupling member 3 is joined to the principal surface 2a of the circuit board 2 such that portions of the plurality of electrodes 31 on the lower surface 3c face the respective electrodes 61 formed on the principal surface 2a of the circuit board 2. The portions of the electrodes 31 on the lower surface 3c and the electrodes 61 are joined to each other through reflowing via an AuSn solder layer (not shown), for example. Alternatively, joining may be made via Au or Cu bumps.

The optical device 4 is disposed on the first surface 3a of the optical coupling member 3 such that the plurality of element planes 42 (light emitting regions 46 or light receiving regions) face the respective holes 33 shown in FIG. 3. Specifically, the optical device 4 is disposed on the surface 3a of the optical coupling member 3 such that the electrode pads 44 and the mechanical pads 45 face the electrodes 31 and the mechanical pads 32 of the optical coupling member 3. The electrodes 31 of the optical coupling member 3 and the electrode pads 44 of the optical device 4 are joined to each other via the bumps 47b, which are, for example, AuSn solder layers using flip chip bonding through ultrasonic waves. Alternatively, the bumps 47b may be Au or

Cu bumps. The mechanical pads 32 of the optical coupling member 3 and the mechanical pads 45 of the optical device 4 are joined to each other via the bumps 47a, which are, for example, AuSn solder layers using flip chip bonding through ultrasonic waves. Alternatively, joining may be made via bumps 47a made of Au or Cu. The bumps 47b are formed to electrically and mechanically join the electrode pads 44 of the optical device 4 and the electrodes 31 of the optical coupling member 3 to each other, and protrude from the element planes 42 in the X-axis direction by 20 to 30 μm, for example. In the case of using the optical device 4 as shown in FIG. 4, the bumps 47b are arranged only at lower portions on the element planes 42 (in the negative direction on the Z-axis in FIG. 4). Consequently, to prevent an inclination from occurring in a case of joining to the optical coupling member 3, the mechanical pads 45 and the bumps 47a are provided at upper portions of the element planes 42 (in the positive direction of the Z-axis in FIG. 4). Consequently, the optical device 4 is mounted so that this device is in parallel to the first surface 3a of the optical coupling member 3. As described above, the optical device 4 is connected to the drive circuit 6 via the electrode pads 44, the electrodes 31, and the electrodes 61. Thus, the optical device 4 is driven by the drive circuit 6.

The optical module 1 is fabricated as follows. First, the optical device 4 is joined to the optical coupling member 3 using flip chip bonding through ultrasonic waves. Next, through reflowing, the optical coupling member 3, to which the optical device 4 is joined, is joined to the circuit board 2, and the drive circuit 6 is joined to the circuit board 2. Next, the holding member 51 is attached to the optical coupling member 3, thus constituting the optical module 1. The optical module 1 is joined, as a subassembly, to a separately provided main substrate (not shown), through reflowing. To join the optical module 1 as the subassembly to the main substrate, a ball grid array can be provided on a rear surface of the circuit board 2 opposite to the principal surface 2a, a part of the rear surface can be formed as an edge connector, or a substrate-to-substrate connector or a printed connector can be implemented on the rear surface. The plurality of optical fibers 5 may be preliminarily implemented on the holding member 51 before the holding member 51 is attached to the optical coupling member 3. Alternatively, after the holding member 51 is attached to the optical coupling member 3, the optical fibers 5 may be implemented on the holding member 51.

In the optical module 1 having the configuration described above, for example, the drive circuit 6 that comprises an integrated circuit (IC) is electrically connected to the optical device 4 via the electrodes 61, the electrodes 31 and the electrode pads 44. The light emission of the optical device 4 is controlled by electric signals from the drive circuit 6. In the optical module 1, light from the optical device 4 enters the optical fibers 5. More specifically, first, when drive signals are input into the optical device 4 via the electrodes and the like by the drive circuit 6, light emission is executed by the light emitting regions 46 of the optical device 4, and the light enters the cores of the optical fibers 5. On the other hand, in a case where the optical device 4 is the light receiving device, the light having propagated through the optical fibers 5 enters the optical device 4 which is the light receiving device. The light having entered the optical device 4 is photoelectrically converted by the optical device 4, and electrical signals are output to the drive circuit 6. In the optical module 1, the optical device 4 and the drive circuit 6 are connected to each other via the electrodes 61 and the like on the circuit board 2. The configuration is not that provided with bonding wires between the optical device 4 and the drive circuit 6. Consequently, the device can have a low profile and achieve a high reliability.

The action and effects obtained by the optical module 1 described above are described. In the optical coupling member 3, the material of the main body 30 is glass. That is, the main body is formed of glass. Accordingly, the main body 30 has a higher heat resistance more resistant to thermal deformation than in the case where the material is a resin. When the main body 30 is mounted on the circuit board 2 or the like through reflowing, the thermal deformation of the main body 30 is suppressed. Consequently, the exfoliation of the mounted components and the deterioration of the members whose heat resistances are low are suppressed. As the material of the main body 30 is glass, absorption of the ultrasonic waves by the main body 30 is suppressed. Accordingly, the optical device 4 can be efficiently mounted on the main body 30 using flip chip bonding through ultrasonic waves. Consequently, the optical device 4 can be accurately mounted on the main body 30. Furthermore, the thermal deformation of the main body 30 is suppressed. Consequently, the optical coupling efficiency between the optical fibers 5 mounted into the respective holes 33 of the main body 30 and the optical device 4 arranged on the first surface 3a of the main body 30 is improved. Thus, the optical coupling member 3 can improve the optical coupling efficiency.

In the optical module 1, the plurality of holes 33 each penetrate from the second surface 3b to the first surface 3a. This aspect can easily form the holes 33 in the main body 30.

In the optical module 1, the main body 30 includes the positioning holes 34. This aspect can accurately mount the optical fibers 5 into the respective holes 33 of the main body 30. When the plurality of optical fibers 5 are mounted into the respective holes 33 at the same time, the optical fibers 5 can be easily and reliably mounted into the holes 33.

In the optical module 1, the main body 30 has a rectangular shape, and can be made as a module where the distance between the first and second surfaces 3a and 3b facing each other is less than 2 mm. This aspect provides a small optical coupling member 3.

In the optical module 1, the outer surfaces of the electrodes 31 are flush with the outer surfaces of the first surface 3a other than the recesses 35. This aspect provides a smaller optical coupling member 3. When the optical device 4 is attached to the main body 30, this device can be accurately attached.

Although the embodiment of the present invention has been described, the present invention is not limited to the embodiment described above, and can be modified in a range without departing from the spirit of the present invention. For example, the optical module may have the following configuration. In the following modification example, the points different from those of the embodiment described above are mainly described, and description of the common points is omitted.

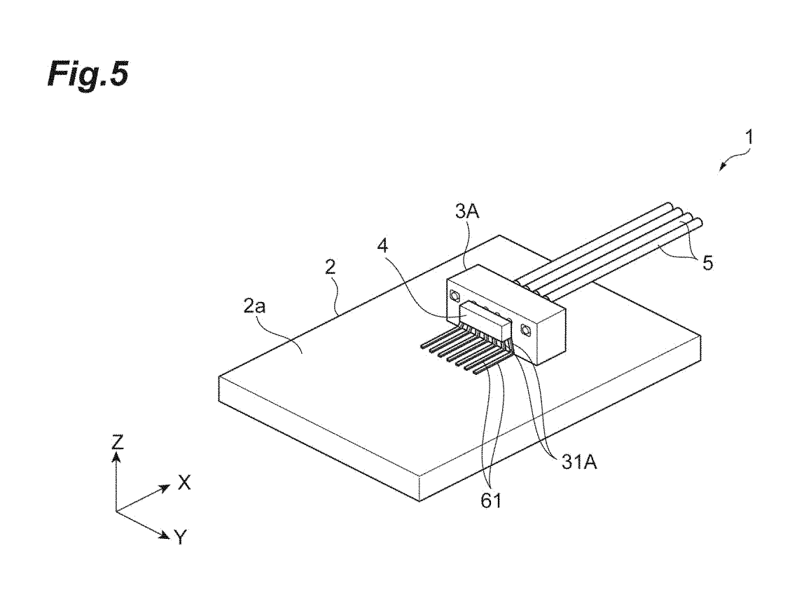

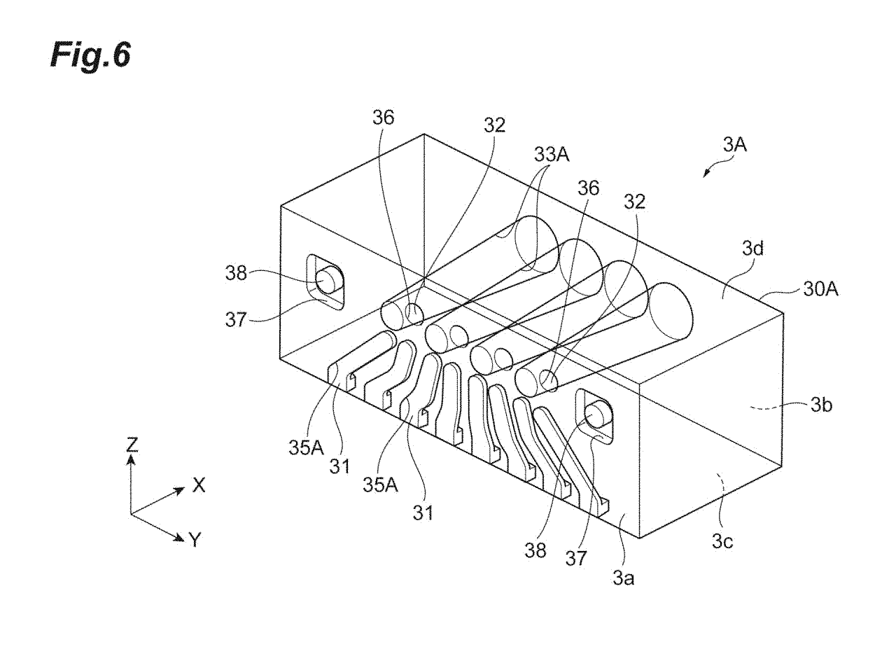

FIG. 5 is a diagram of a modification example of an optical module. In FIG. 5, the holding member 51, the hold member 52 and the drive circuit 6 are omitted. FIG. 6 is a perspective view of an optical coupling member 3A included in the optical module shown in FIG. 5. As shown in FIG. 6, the optical coupling member 3A comprises a main body 30A. In the optical coupling member 3A according to the modification example, the main body 30A is different from the main body 30 of the optical coupling member 3. The first surface 3a of the main body 30A is provided with a plurality of (eight in this embodiment) recesses 35A for allowing the plurality of electrodes 31 to be arranged therein. The plurality of recesses 35A extend lower than the holes 33A on the first surface 3a along the Z-axis direction to the lower surface 3c. The plurality of recesses 35A are formed along the Y-axis direction. The distances between recesses 35A in the Y-axis direction widen toward the lower surface 3c. In this case, when portions of the electrodes 31 on the lower surface 3c of the optical coupling member 3A and the electrodes 61 are joined to each other via, for example, an AuSn solder layer (not shown) through reflowing, the formation of bridges of AuSn solder layers between the electrodes is suppressed. The distances between the recesses 35A in the Y-axis direction are each about 0.1 to 0.2 mm, for example. The plurality of electrodes 31 are accommodated in the respective recesses 35.

The main body 30A is not provided with the positioning holes 34. On the other hand, the first surface 3a of the main body 30A is provided with a plurality (a pair in this embodiment) of non-through holes 37. In the non-through holes 37, protrusions 38 are respectively provided. The non-through holes 37 and the protrusions 38 constitute fiducial marks that serve as references of the position of the main body 30A when the optical device is joined. Note that the fiducial mark is not necessarily formed. Here, the holes 33A serve as the reference of the position of the main body 30A.

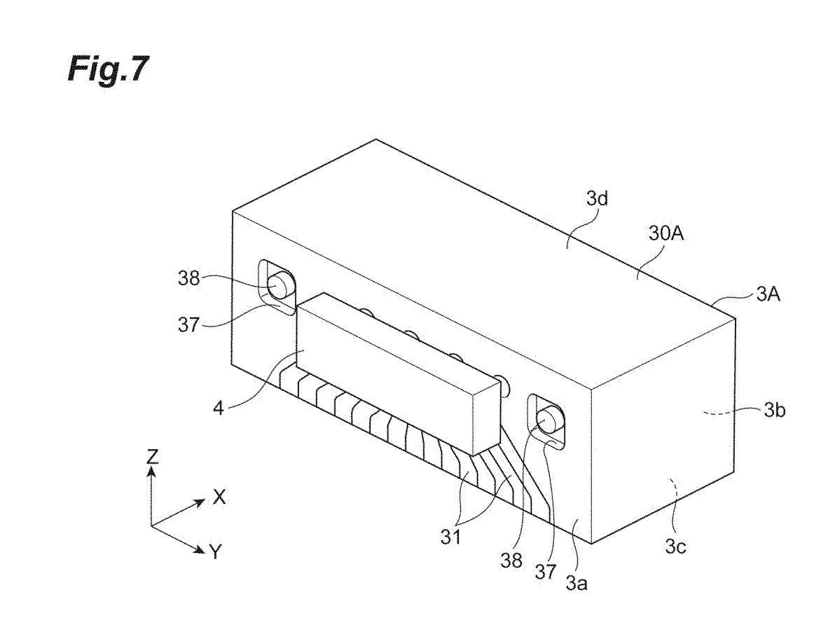

FIG. 7 is an enlarged view of the optical coupling member 3A and the optical device 4 which are included in the optical module shown in FIG. 5. As shown in FIG. 7, in a manner analogous to that described above, the optical device 4 is disposed on the first surface 3a of the optical coupling member 3A such that the plurality of optical surfaces face the respective holes 33A.

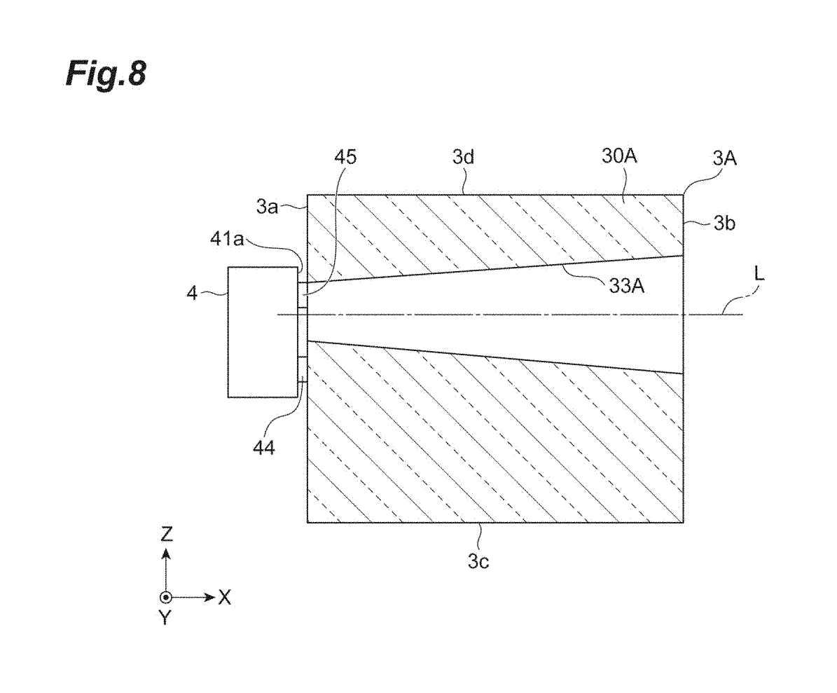

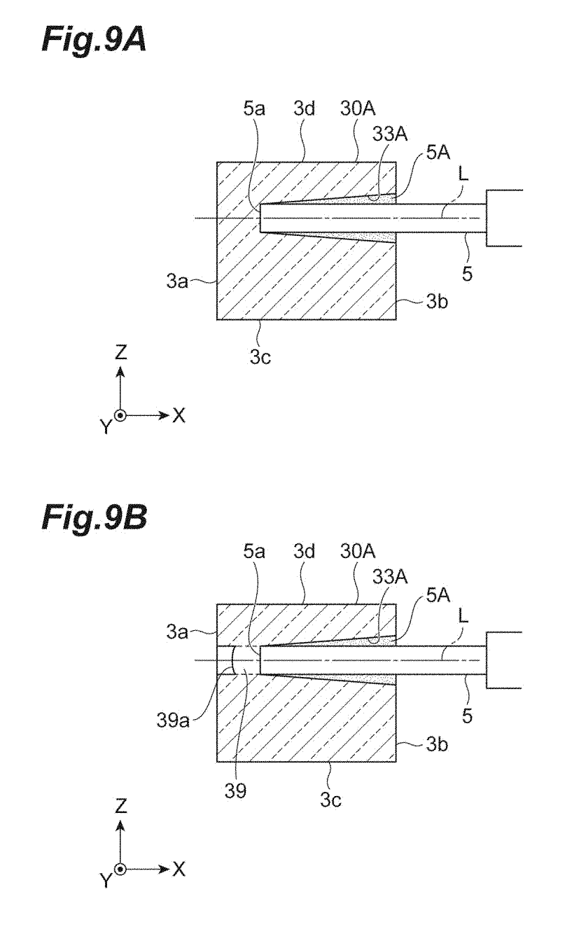

FIG. 8 is a partial sectional view of the optical coupling member 3A and the optical device 4 shown in FIG. 7. As shown in FIG. 8, the plurality of holes 33A each have a tapered shape decreasing in size from the second surface 3b to the first surface 3a of the main body 30A. Specifically, the inner surfaces of the plurality of holes 33A each have a tapered shape having an inclination of 1° or more from central axes L of the plurality of hole 33A. The inner surfaces of the plurality of holes 33A have tapered shapes having, for example, an inclination of 1° from the central axes L of the plurality of holes 33A. The diameters of the plurality of holes 33A provided on the first surface 3a of the optical coupling member 3A are substantially equivalent to the outer diameters of the respective optical fibers 5. That is, the diameters of the plurality of holes 33A provided on the second surface 3b of the optical coupling member 3A are larger than the diameters of the optical fibers 5. Accordingly, when the optical fibers 5 are inserted into the holes 33 from the second surface 3b, the distal ends 5a (see FIG. 9A) of the optical fibers 5 are prevented from coming into contact with the main body 30 and thereby being chipped.

As described above, the optical module 1 including such an optical coupling member 3A can allow the light from the optical device 4 (light emitting device) to enter the core of the optical fiber 5, and allow the light from the optical fiber 5 to enter the optical device 4 (light receiving device).

In the optical module 1, the plurality of holes 33A each penetrate from the second surface 3b to the first surface 3a. However, as shown in FIG. 9A, the plurality of holes 33A may extend from the second surface 3b to the middles of the paths reaching the first surface 3a, and may thus be non-through holes. In this case, the optical fibers 5 are inserted into the respective holes 33A such that the distal ends 5a are in contact with the bottom surfaces of the holes 33A. That is, the distal end position of the optical fiber 5 is regulated by the bottom surface of the hole 33A. Accordingly, the position of the optical fiber 5 with respect to the optical coupling member 3 is defined. In this case, the distal end 5a of the optical fiber 5 can be in contact with the bottom surface of the hole 33A, thereby facilitating the positioning of the optical fiber 5. The plurality of optical fibers 5 may be fixed to the respective holes 33A with a photocurable resin adhesive 5A. In this case, since the material of the main body 30 is glass, the plurality of optical fibers 5 can be preferably fixed in the respective holes 33A with the photocurable resin adhesive 5A. In this case, first, the optical coupling member 3A is joined onto the main substrate through reflowing, and subsequently, the plurality of optical fibers 5 are fixed in the respective holes 33A with the photocurable resin adhesive 5A. In this example, the holes 33A do not penetrate. Accordingly, the optical fibers 5 are prevented from coming into contact with and scratching the optical device 4.

As shown in FIG. 9B, the main body 30A may include lenses 39 at the distal ends of the respective holes 33A. The lens 39 may be formed integrally with the main body 30A, or may be formed by forming a through-hole including the hole 33A in the main body 30A, subsequently by inserting or pressing a member of the lens 39, and by fixing the member at a predetermined position. Alternatively, the lens 39 may be formed by inserting or pressing a lens member into a non-through hole provided on the opposite side of the hole 33A of the main body 30A and by fixing the member at a predetermined position. In this case, the lens 39 comprises a portion clamped by the non-through hole provided on the opposite side of the hole 33A of the main body 30A and by the hole 33A, and the inserted or pressed lens member. The lens 39 is formed of a material that allows communication light having a predetermined wavelength to transmit therethrough. It is preferable that the total light transmittance be 90% or higher for light having a wavelength of about 850 nm in the case of a thickness of 1 mm, for example. The lens 39 may be formed of the same material as that of the main body 30A.

The lens 39 is provided with a lens surface 39a on a side of the first surface 3a. The lens surface 39a is convex toward the first surface 3a, and has a function of condensing light from the optical device 4 and allowing the light to enter the optical fiber 5. The length of such a lens 39 along the X-axis direction may be, for example, about 200 μm. The outer diameter may be, for example, about 125 μm. To allow the light from the optical device 4 to enter the optical fiber 5 with a high optical coupling efficiency, the optical coupling member 3 is configured so that the central axis L of the hole 33A (the optical axis of the optical fiber 5) and the optical axis of the lens surface 39a of the lens 39 are disposed on the identical axis. In this case, the lenses 39 condense light between the optical fibers 5 mounted in the respective holes 33A in the main body 30A and the optical device 4 disposed on the first surface 3a of the main body 30A. Accordingly, a high optical coupling efficiency can be achieved.

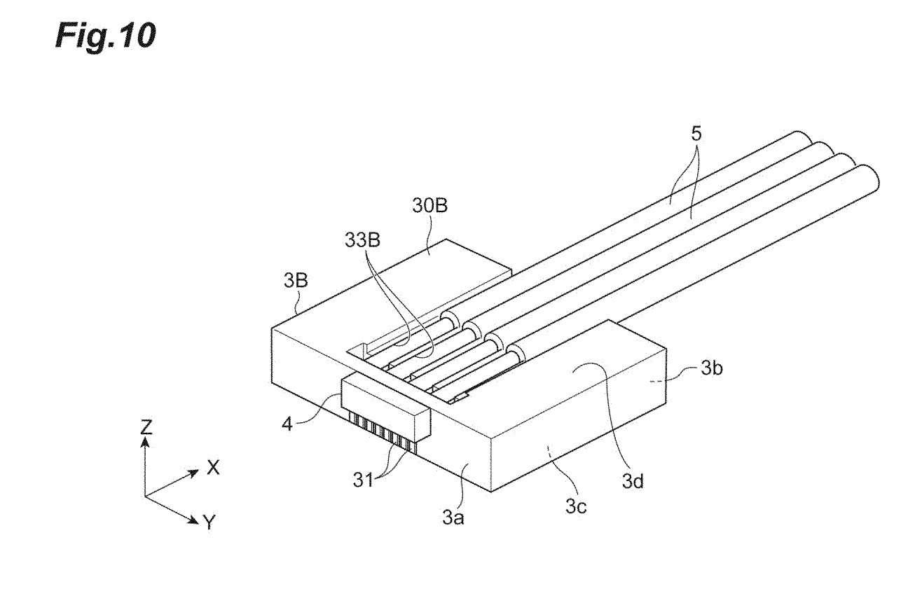

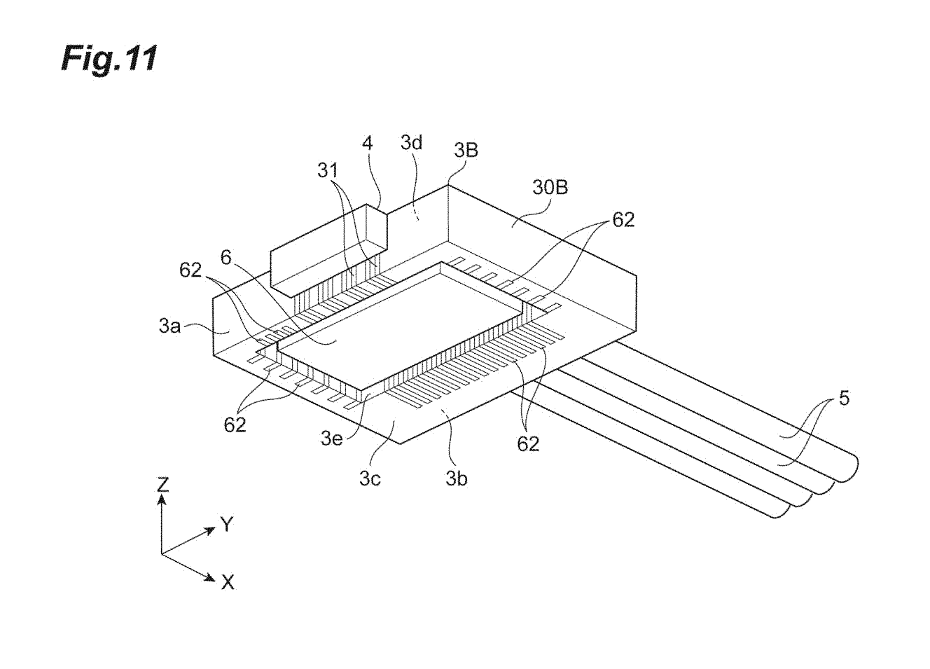

FIG. 10 is a diagram of a modification example of an optical module. As shown in FIG. 10, instead of the plurality of holes 33 and 33A, a plurality of grooves 33B into which the optical fibers 5 extending from the second surface 3b toward the first surface 3a are to be inserted are provided for a main body 30B of an optical coupling member 3B. The plurality of optical fibers 5 are mounted on the respective grooves 33B. FIG. 11 is a perspective view of the optical coupling member 3B of the optical module shown in FIG. 10 as viewed from the lower surface 3c of the optical coupling member 3B. As shown in FIG. 11, a recess 3e is provided on an outer surface of the main body 30B other than the first and second surfaces 3a and 3b. Specifically, the lower surface 3c of the main body 30B is provided with the recess 3e. The drive circuit 6 is accommodated in the recess 3e. The drive circuit 6 is accommodated in the main body 30B. That is, the drive circuit 6 is accommodated more inside of the main body 30B than the lower surface 3c of the main body 30B. The drive circuit 6 is electrically connected to the optical device 4 via the electrodes 31. The drive circuit 6 is electrically connected to the circuit board (not shown) via electrodes 62. In this case, the optical module can be further reduced in size, and can be treated as a module component that includes the drive circuit.

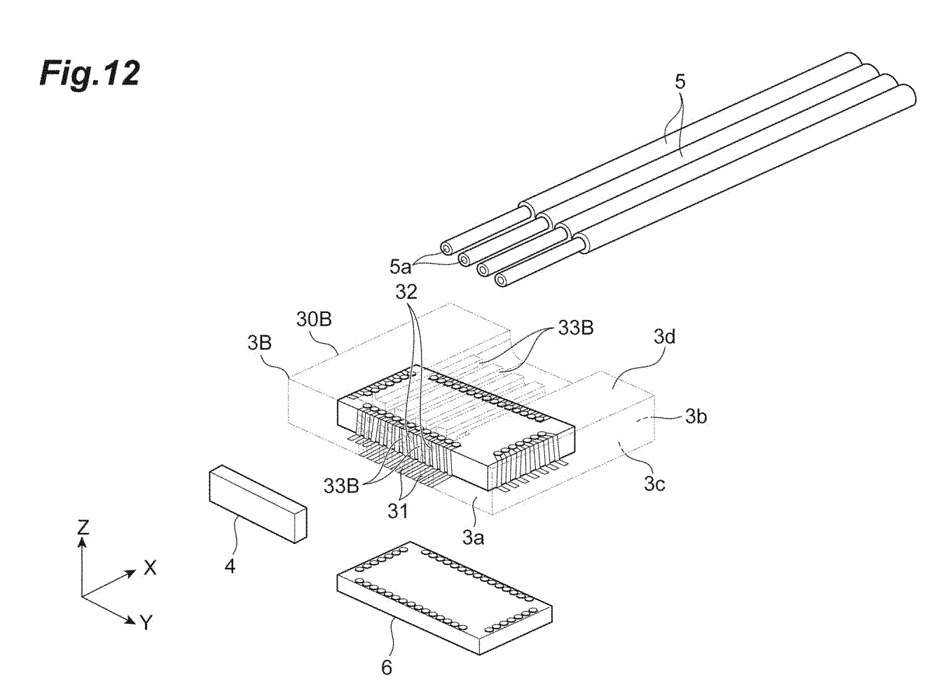

FIG. 12 is an exploded view of the optical module shown in FIG. 10. As shown in FIG. 12, the plurality of grooves 33B are open toward an upper surface 3d of the main body 30B. The plurality of grooves 33B each penetrate from the second surface 3b to the first surface 3a. In FIG. 12, to clarify the internal structure of the main body 30B, the outlines of the main body 30B are represented by chain double-dashed lines. The other configurations of the plurality of grooves 33B are analogous to those of the plurality of holes 33 and 33A. That is, the plurality of grooves 33B may each have a tapered shape decreasing in size from the second surface 3b to the first surface 3a of the main body 30B. Specifically, the inner surfaces of the plurality of grooves 33B may have tapered shapes having an inclination of 1° or more from the central axes L of the respective grooves 33B. The plurality of grooves 33B may each extend from the second surface 3b to the middle of the path reaching the first surface 3a, and be a non-through hole. The plurality of optical fibers 5 may be fixed to the respective grooves 33B with the photocurable resin adhesive.

What is claimed is:

1. An optical coupling member, comprising:
a main body consisting essentially of glass, the main body comprising a first surface, a second surface opposite to the first surface, and a plurality of holes or grooves each extending from the second surface toward the first surface; and
an electrode disposed on the first surface of the main body.

2. The optical coupling member according to claim 1,
wherein the plurality of holes or grooves each have tapered shapes becoming smaller from the second surface toward the first surface.

3. The optical coupling member according to claim 2,
wherein inner surfaces of the plurality of holes or grooves have tapered shapes having an inclination of 1° or more from central axes of the respective holes or grooves.

4. The optical coupling member according to claim 2,
wherein the plurality of holes or grooves each penetrate from the second surface to the first surface.

5. The optical coupling member according to claim 2,
wherein the plurality of holes or grooves each extend from the second surface to middles of paths to the first surface and do not penetrate therethrough.

6. The optical coupling member according to claim 5,
wherein the main body further comprises lenses at distal ends of the respective holes or grooves.

7. The optical coupling member according to claim 2,
wherein the main body further comprises a positioning hole extending from the second surface toward the first surface.

8. The optical coupling member according to claim 2,
wherein the main body has a rectangular shape, and a distance between the first and second surfaces facing each other is smaller than 2 mm.

9. The optical coupling member according to claim 2,
wherein the first surface includes a recess for arranging the electrode therein, and the electrode is accommodated in the recess so that an outer surface of the electrode is flush with an outer surface of the first surface other than the recess.

10. An optical module, comprising:
an optical coupling member comprising:
a main body consisting essentially of glass, the main body comprising a first surface, a second surface opposite to the first surface, and a plurality of holes or grooves each extending from the second surface toward the first surface; and
an electrode disposed on the first surface of the main body; and
an optical device disposed on the first surface of the main body so as to face the plurality of holes or grooves.

11. The optical module according to claim 10,
wherein the plurality of holes or grooves each have tapered shapes becoming smaller from the second surface toward the first surface.

12. The optical module according to claim 11, further comprising
a circuit board, wherein the optical coupling member is joined to the circuit board.

13. The optical module according to claim 12, further comprising
a drive circuit configured to drive the optical device, wherein the drive circuit is mounted on the circuit board, and is electrically connected to the optical device via the electrode.

14. The optical module according to claim 12, further comprising
a drive circuit configured to drive the optical device, wherein the drive circuit is accommodated in a recess provided on an outer surface of the main body other than the first and second surfaces, and is electrically connected to the optical device via the electrode.

15. The optical module according to claim 11, further comprising
a plurality of optical fibers arranged in the respective holes or grooves of the main body.

16. The optical module according to claim 15,
wherein the plurality of optical fibers are fixed to the respective holes or grooves with a photocurable resin adhesive.

17. The optical module according to claim 11,
wherein inner surfaces of the plurality of holes or grooves have tapered shapes having an inclination of 1° or more from central axes of the respective holes or grooves.

18. The optical module according to claim 11,
wherein the plurality of holes or grooves each penetrate from the second surface to the first surface.

19. The optical module according to claim 11, further comprising
a plurality of optical fibers; and
a holding member that holds the plurality of optical fibers, the holding member including a pair of protruded positioners,
wherein the main body further comprises a pair of positioning holes each extending from the second surface toward the first surface, and the pair of protruded positioners each are inserted to the pair of positioning holes so as to position the holding member with respect to the main body.

20. The optical module according to claim 11,
wherein the main body has a rectangular shape, and a distance between the first and second surfaces facing each other is smaller than 2 mm.
